(19) United States
(12) Patent Application Publication
(10) Pub. No.: US 2018/0070091 A1
(43) Pub. Date: Mar. 8, 2018

(54) Improved Compression in High Dynamic Range Video

(71) Applicant: Telefonaktiebolaget LM Ericsson (publ), Stockholm (SE)

(72) Inventor: Olie Baumann, Southampton (GB)

(21) Appl. No.: 15/559,594

(22) PCT Filed: Apr. 10, 2015
(86) PCT No.: PCT/EP2015/057901

§ 371 Date: Sep. 19, 2017

(51) Int. Cl. H04N 19/15; G09G 5/06; H04N 19/102; H04N 19/172; H04N 19/46

(52) U.S. Cl. CPC H04N 19/15; G09G 5/06; H04N 19/102; H04N 19/176; H04N 19/46; G09G 2320/0276; G09G 2340/06; H04N 19/172

(57) ABSTRACT

There is provided a method in a video encoding apparatus, the method comprising applying a transfer function to tristimulus values detected by a video camera, the transfer function selected based on the video content.

### TECHNICAL FIELD

The present application relates to a method in a video encoding apparatus, a video encoding apparatus, an apparatus for encoding video, a method in a video decoding apparatus, a video decoding apparatus, and a computer-readable medium.

### BACKGROUND

This application concerns the transfer function pair often referred to independently as the Opto-Electrical (OETF) and Electro-Optical (EOTF) transfer functions. The opto-electrical transfer function (OETF) is applied to the output of an electronic optical sensor as a first step to generating a digital image file. The optical sensor outputs a raw video signals, which is a linear measure of light intensity for each of the red, green and blue signals. These values are the tristimulus values. The application of these transfer functions both after image capture and before image display is sometimes broadly referred to as gamma correction.

The OETF may be applied in the camera at the output of the sensor, and before camera output. Alternatively the camera may output the tristimulus values and the OETF is then applied by a mixing desk or colour grading suite.

Historically, the purpose of the OETF was to pre-compensate for the EOTF inherent in cathode ray tube (CRT) displays. Despite the decline in use of CRTs, the use of these transfer functions has been maintained through the ITU-R Rec. 601 and ITU-R Rec. 709 standards. Since the demise of CRT displays a reference EOTF has been standardized in ITUR Rec. 1886 (and subsequently ITU-R Rec. 2020) ensuring that modern displays maintain compatibility with video signals encoded with the standard OETFs.

A typical OETF is a power law that gives a non-linear function of linear luminance to transformed values. The non-linearity results in more transform values being available for the low luminosity values of an image. One reason for the persistence of transform functions since CRTs fell out of use is that a power law OETF can take advantage of the non-linear manner in which the human visual system works to reduce the size of digital image files. The human visual system (HVS) is more sensitive to differences in darker tones than brighter ones, and an appropriate power law results in fewer bits being applied to encoding brighter levels which the HVS cannot distinguish.

An example of a typical video signal from camera to display using the 709 OETF/1886 EOTF pair is depicted in FIG. 1. A video camera 110 receives light through a lens system and generates electrical signals corresponding to the image detected. These electrical signals are the tristimulus values, RGB, indicating the amount of red, green and blue light detected. An OETF module 120 applies an OETF such as that described in ITU-R Rec. 709 to the tristimulus values to generate R′G′B′, which are then quantized at the quantization module 130 to generate digital values suitable for compression at the compression module 140. It should be noted that the quantization module 130 will often also apply colour space conversion (for example from R′G′B′ to YCbCr as also defined, for example, in ITU-R Rec 709). Further, it should be noted that the video signal is also subjected to a compression stage converting the video signal into a format such as MPEG 2, MPEG 4 AVC or HEVC.

The parallel slanted lines between compression 140 and reconstruction 150 in FIG. 1 indicate a transmission step and separate the encoding side on the left from the decoding side on the right. In the decoding apparatus, the received video signal is decoded and reconstructed by reconstruction module 150 and then an EOTF such as ITU-R Rec. 1886 is applied by EOTF module 160 prior to the video being output on display 170. It should be noted that in many cases the EOTF is an integral part of the display. (In a CRT the EOTF is a physical characteristic of the display, modern flat panel displays (LCD, Plasma, OLED, etc) have an EOTF integrated into them by way of an algorithmic implementation in the driving electronics/software).

As display technologies advance (LCD, Plasma, OLED, etc) displays are becoming capable of generating both darker and brighter luminance levels. This is a greater dynamic range than traditional display equipment and can be referred to as a high dynamic range (HDR). It has been observed that simply stretching video signals encoded using existing transfer functions to cover the wider range of luminance values has the undesirable effect of introducing quantization artefacts (often referred to as banding) in the displayed image. Such artefacts are most obvious at lower luminance levels, a phenomenon attributed to the higher sensitivity of the human visual system (HVS) to contrast changes at lower luminance levels. One solution to this problem is to increase the bit depth used to encode the video signal and thus reduce the difference between levels. Whilst this may be relatively simple it is also relatively inefficient since video at higher luminance levels, where the human visual system is not capable of discerning such small changes in contrast, will also be more finely quantized.

An alternative solution is to employ a more aggressive transfer function which redistributes the quantization levels to have a higher resolution at lower luminance levels. FIG. 2 shows the comparison of the distribution of quantization levels in the linear domain for two different transfer functions, FIG. 2a showing a more aggressively non-linear transfer function than that of FIG. 2b. The more non-linear function of FIG. 2a affords more quantization levels to lower luminance data. One such transfer function has been proposed in SMPTE standard ST 2084.

Recommendation ITU-R BT.601-7, March 2011, (available from www.itu.int), is titled Studio encoding parameters of digital television for standard 4:3 and wide-screen 16:9 aspect ratios and at section 2.6 it defines colour and opto-electronic transfer characteristics for conventional television systems.

Recommendation ITU-R BT.709-5, April 2002, (available from www.itu.int), is titled Parameter values for the HDTV standards for production and international programme exchange. This document includes a definition of an OETF.

Recommendation ITU-R BT.2020-1, June 2014, (available from www.itu.int) is titled Parameter values for ultra-high definition television systems for production and international programme exchange. This document defines a reference EOTF.

### SUMMARY

The inventors have identified that the compression efficiency is impacted by the change in transfer function and also that this impact is dependent upon the video content. That is, the compression efficiency of a video encoding stage can be improved by selecting an appropriate transfer function, and which transfer function to select is dependent upon the video content that is being encoded. In other words, the compression efficiency for a particular video sequence is improved by using an adaptive transfer function.

Accordingly, there is provided a method in a video encoding apparatus, the method comprising applying a transfer function to tristimulus values detected by a video camera, the transfer function selected based on the video content.

A variation in the encoding efficiency of video compression dependent upon the opto-electrical transfer function applied to a video signal has been identified. This variation is exhibited as a variation in the number of bits required to encode the video for a given quantization parameter. Selecting the optimal opto-electrical transfer function can thus reduce the number of bits required to encode a video scene without impairing the quality of that encoding.

The application of the transfer function to the tristimulus values may comprise the application of the transfer function to a sub-set or a combination of the tristimulus values. In particular, in the case of constant luminance each of the plurality of transfer functions is applied to a combination of the tristimulus values.

The tristimulus values may comprise native camera tonal levels. Basing the selection upon the video content may comprise the transfer function being selected based upon a property of the video content. The transfer function may be selected to optimize compression of the video content.

The tristimulus values detected by a camera may be obtained by applying an inverse transfer function to a received video signal, the received video signal having had a transfer function applied to it.

The tristimulus video values may be analyzed to identify an optimum transfer function. The analysis may comprise applying each of a plurality of transfer functions to the tristimulus values; encoding the result from each transfer function; and comparing the encoding efficiency for the result of each transfer function.

The plurality of transfer functions each applied to the tristimulus values may comprise a preselected range of transfer functions. The selection of the optimal transfer function is performed using a trial encoding stage, whereby a pre-encode or test encode is performed using each of a plurality of preselected transfer functions.

The method may further comprise encoding the video content after the selected transfer function has been applied to the tristimulus values detected by the video camera. The method may further comprise encoding an indication of the selected transfer function with the video content.

There is further provided a video encoding apparatus arranged to apply a transfer function to tristimulus values detected by a video camera, the transfer function selected based on the video content. Basing the selection upon the video content may comprise the transfer function being selected based upon a property of the video content.

The transfer function may be selected to optimize compression of the video content. The tristimulus values detected by a camera may be obtained by applying an inverse transfer function to a received video signal, the received video signal having had a transfer function applied to it.

The tristimulus video values may be analyzed to identify an optimum transfer function. The video encoding apparatus may further comprise: a plurality of transfer function modules arranged to apply each of a plurality of transfer functions to the tristimulus values; a plurality of pre-encoding modules arranged to encode the result from each transfer function; and a comparison module arranged to compare the output of each pre-encoding module.

The video encoding apparatus may further comprise an encoding module arranged to encode the video content after the selected transfer function has been applied to the tristimulus values detected by the video camera. The encoding module may be further arranged to encode an indication of the selected transfer function with the video content.

There is further provided an apparatus for encoding video comprising a processor and a memory, said memory containing instructions executable by said processor whereby said apparatus is operative to apply a transfer function to tristimulus values detected by a video camera, the transfer function selected based on the video content. Basing the selection upon the video content may comprise the transfer function being selected based upon a property of the video content.

There is further provided a method in a video decoding apparatus, the method comprising: receiving an encoded video signal including an indication of a transfer function; decoding the encoded video content; and applying the transfer function indicated in the video signal to the encoded video content.

There is further provided a video decoding apparatus arranged to: receiving an encoded video signal including an indication of a transfer function; decoding the encoded video content; and applying the transfer function indicated in the video signal to the encoded video content.

There is further provided a computer-readable medium, carrying instructions, which, when executed by computer logic, causes said computer logic to carry out any of the methods defined herein.

There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

### BRIEF DESCRIPTION OF THE DRAWINGS

An apparatus and method for improved video compression efficiency will now be described, by way of example only, with reference to the accompanying drawings, in which:

FIG. 1 shows an example of a typical video signal processing chain from a camera to a display;

FIG. 2 shows the comparison of the distribution of quantization levels in the linear domain for two different transfer functions;

FIG. 3 shows an example of the video processing system described herein

FIG. 4 illustrates a method in a video encoding apparatus;

FIG. 5 illustrates another method in a video encoding apparatus; and

FIG. 6 illustrates an apparatus for encoding video.

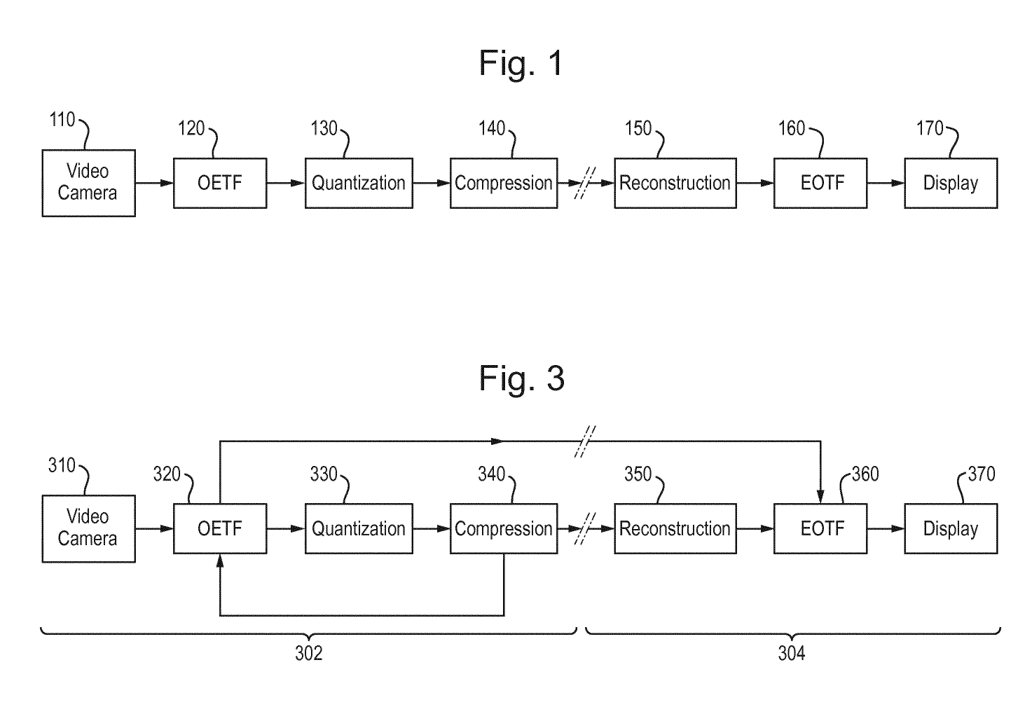

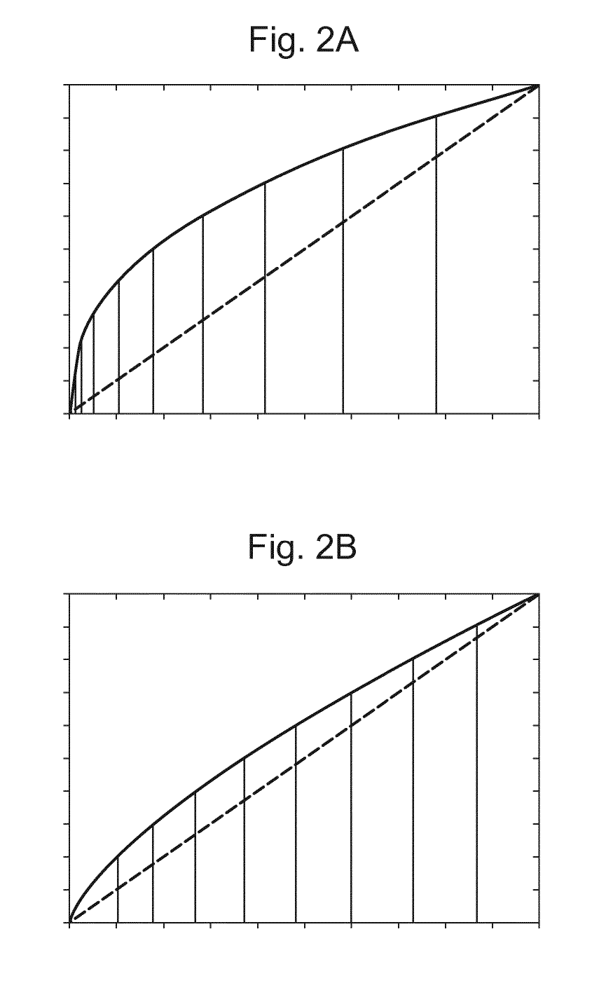

### DETAILED DESCRIPTION

There is described herein a video processing system in which an adaptive parametric OETF/EOTF pair is used in the coding and decoding of video signals for compression.

An example of the video processing system described herein is shown in FIG. 3. A video camera 310 receives light through a lens system and generates electrical signals corresponding to the image detected. These electrical signals are the tristimulus values. An OETF module 320 applies a parametric OETF to the tristimulus values. The parameters of the parametric OETF may be modified or adapted in accordance with some measure of compression efficiency. This adaptation is illustrated by a feedback loop from compression module 340 to the OETF module 320. The modified values are then quantized at quantization module 330 to generate digital values suitable for compression at compression module 340. Compression module 340 can use any form of video compression and may be, for example, H.264 or H.265 compression. In addition to the compression there may be metrics which measure the compression efficiency based on, for example the peak signal to noise ratio (PSNR) between input and output images. These metrics are used to provide feedback to optimize the parameters of the parametric OETF.

The parallel slanted lines between the compression module 340 and the reconstruction module 350 in FIG. 3 indicate a transmission step and separate the encoding apparatus 302 on the left from the decoding apparatus 304 on the right. In the decoding apparatus 304, the received video signal is decoded and reconstructed by reconstruction module 350 resulting in an uncompressed, quantized video signal. Then a parametric EOTF is applied by EOTF module 360, the parameters for which are selected to provide an inverse to the OETF applied by OETF module 320. It is not necessary for the EOTF to be the perfect inverse of the OETF. For example, some redistribution of the luminance levels may be desired, and this may be termed the “system gamma”.

The transmission step between the compression module 340 and the reconstruction module 350 in FIG. 3, may take a plurality of forms. The transmission may comprise a remote site uplink to a broadcaster, the transmission may comprise distribution from a broadcaster to a user device over satellite, cable or terrestrial broadcast. Further, the transmission may comprise a streaming session over an IP network. Also, the transmission may comprise distribution over physical media, that is the video being recorded to a physical media and the user subsequently playing the physical media in user equipment.

The transfer function pair may be any parameterized function such as (but not limited to) the power function:

y=x^{γ}

where y is the transform of the original tristimulus video signal x and γ is the adaptation parameter. The value of γ will be associated with a segment of the video sequence where the segment may correspond to, for example, a scene, an image, an image slice or a macroblock or coding tree unit. Furthermore there may be multiple values for any segment each associated with one or more of the video tristimulus channels. The choice of γ for a given sequence segment may be made based on some measure of sequence content. One example of such a measure might be the average luminance level. Alternatively the value of γ may be based on some objective measure of compression efficiency. This could be identified by running a test encode using each of a plurality of a preselected range of transfer functions.

In one example, the available transfer functions are defined as a preselected set of values for γ, such as {0.4, 0.5, 0.6, 0.7}. Alternatively, any value of γ may be chosen and an indication of this value is included in the encoded video signal.

Regardless of the nature of the transfer function, it must be identified and transmitted with the video segment as meta-data. An indication of the transfer function is thus included in the encoded video signal. This is required such that the indication can be read by the EOTF once the video stream has been decoded. The indication is then used to generate the EOTF which is applied to the video signal to produce the tristimulus data for display. The indication of a transfer function may comprise the identification of one option from a preselected list of transfer functions common to the encoder and decoder. Alternatively, the indication may comprise the parameters required to define the transfer function.

It has been identified that a variation in the encoding efficiency of video compression dependent upon the opto-electrical transfer function applied to a video signal. This variation is exhibited as a variation in the number of bits required to encode the video for a given quantization parameter. Selecting the optimal opto-electrical transfer function can thus reduce the number of bits required to encode a video scene without impairing the quality of that encoding.

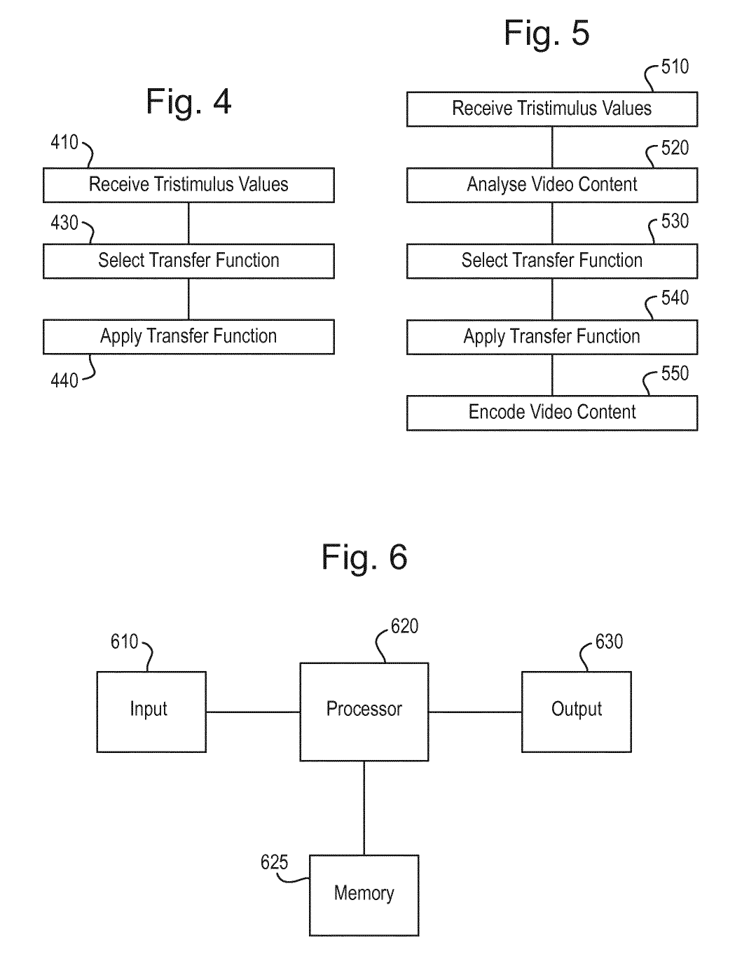

FIG. 4 illustrates a method in a video encoding apparatus, the method comprising receiving 410 tristimulus values detected by a video camera, selecting a transfer function based on the video content 430, and applying 440 the selected transfer function to the tristimulus values. The transfer function may be selected based upon a property of the video content.

In some cases, the method may be employed to a signal received from a camera, where the camera has already applied an OETF to the tristimulus values. In such a situation the tristimulus values detected by a camera are obtained by applying an inverse transfer function to the received video signal.

The transfer function may be selected to optimize compression of the video content. To facilitate this, the tristimulus video values may be analyzed to identify an optimum transfer function. This analyzing may comprise applying each of a plurality of transfer functions to the tristimulus values, encoding the result from each transfer function, and comparing the encoding efficiency for the result of each transfer function.

The plurality of transfer functions each applied to the tristimulus values may comprise a preselected range of transfer functions. The selection of the optimal transfer function may be performed using a trial encoding stage, whereby a test encode is performed using each of a plurality of preselected transfer functions.

FIG. 5 illustrates another method in a video encoding apparatus, the method comprising receiving 510 tristimulus values detected by a video camera, analyzing 520 the received video content and selecting 530 a transfer function based on the video content. The method further comprises applying 540 the selected transfer function to the tristimulus values, and encoding 550 the video content after the selected transfer function has been applied. An indication of the selected transfer function is encoded with the video content.

There is further provided a video encoding apparatus arranged to apply a transfer function to tristimulus values detected by a video camera, the transfer function selected based on the video content, or a property of the video content.

FIG. 6 illustrates an apparatus for encoding video comprising an input 610, processor 620, a memory 625, and an output 630. The memory 625 contains instructions executable by said processor 625 whereby said apparatus is operative to apply a transfer function to tristimulus values detected by a video camera and received by input 610, the transfer function selected based on the video content, which may include the selection being based on a property of the video. The modified tristimulus values are nonlinear voltage signals and are output by output 630.

The processor 620 is arranged to receive instructions which, when executed, causes the processor 620 to carry out the above described method. The instructions may be stored on the memory 625.

There is further provided a method in a video decoding apparatus, the method comprising: receiving an encoded video signal including an indication of a transfer function; decoding the encoded video content; and applying the transfer function indicated in the video signal to the encoded video content.

There is further provided a video decoding apparatus arranged to: receiving an encoded video signal including an indication of a transfer function; decoding the encoded video content; and applying the transfer function indicated in the video signal to the encoded video content.

There is further provided a computer-readable medium, carrying instructions, which, when executed by computer logic, causes said computer logic to carry out any of the methods defined herein. There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope

Reference is made herein to a transfer function that is a power law. This is merely an example, and the transfer function could be any monotonic function. The transfer function could also be defined by different equations for different ranges, for example the Rec. 709 transfer function (OETF) from the linear signal (luminance) to the nonlinear (voltage) is defined as:

$$V = \{ \begin{matrix}4.500 L & L < 0.018 \\ 1.099 {L}^{0.45} - 0.099 & L \geq 0.018\end{matrix} .$$

This transfer function has a linear part at low luminance and follows a power law at higher luminance.

The application of each of a plurality of transfer functions to the tristimulus values may comprise the application of the transfer function to a sub-set or a combination of the tristimulus values. In particular, in the case of constant luminance each of the plurality of transfer functions is applied to a combination of the tristimulus values.

The method may also be embodied in a set of instructions, stored on a computer readable medium, which when loaded into a computer processor, Digital Signal Processor (DSP) or similar, causes the processor to carry out the hereinbefore described method of encoding or decoding video.

Equally, the method may be embodied as a specially programmed, or hardware designed, integrated circuit which operates to carry out the method on video data loaded into the said integrated circuit. The integrated circuit may be formed as part of a general purpose computing device, such as a PC, and the like, or it may be formed as part of a more specialized device, such as a games console, mobile phone, portable computer device or hardware video encoder.

One exemplary hardware embodiment is that of a Field Programmable Gate Array (FPGA) programmed to carry out the described method, located on a daughterboard of a rack mounted video encoder, for use in, for example, a television studio or satellite or cable TV head end.

Another exemplary hardware embodiment of the present invention is that of a video encoder and/or video decoder comprising an Application Specific Integrated Circuit (ASIC).

1-18. (canceled)

19. A method in a video encoding apparatus, the method comprising:
taking a statistical measure of image luminance of tristimulus values detected by a video camera;
applying a transfer function to the tristimulus values detected by the video camera, wherein the transfer function is a parameterized function defined by at least one parameter; and
wherein the transfer function selected based on the statistical measure of image luminance.

20. The method of claim 19, wherein the transfer function is selected to optimize compression of the video content.

21. The method of claim 19, wherein the tristimulus values detected by a camera are obtained by applying an inverse transfer function to a received video signal, the received video signal having had an input transfer function applied to it at image capture, the inverse transfer function being the inverse of the input transfer function.

22. The method of claim 19, wherein the tristimulus video values are analyzed to identify an optimum transfer function.

23. The method of claim 22, wherein the analyzing comprises:
applying each of a plurality of transfer functions to the tristimulus values;
encoding the result from each transfer function; and
comparing the encoding efficiency for the result of each transfer function.

24. The method of claim 19, further comprising encoding the video content after the selected transfer function has been applied to the tristimulus values detected by the video camera.

25. The method of claim 19, further comprising encoding an indication of the selected transfer function with the video content.

26. A video encoding apparatus, comprising:
processing circuitry;
memory containing instructions executable by the processing circuitry whereby the video encoding apparatus is operative to:
take a statistical measure of image luminance of tristimulus values detected by a video camera;
apply a transfer function to the tristimulus values detected by the video camera;
wherein the transfer function is a parameterized function defined by at least one parameter;
wherein the transfer function is selected based on the statistical measure of image luminance.

27. The video encoding apparatus of claim 26, wherein the instructions are such that the video encoding apparatus is operative to select the transfer function to optimize compression of the video content.

28. The video encoding apparatus of claim 26, wherein the tristimulus values detected by a camera are obtained by applying an inverse transfer function to a received video signal, the received video signal having had an input transfer function applied to it at image capture, the inverse transfer function being the inverse of the input transfer function.

29. The video encoding apparatus of claim 26, wherein the instructions are such that the video encoding apparatus is operative to analyze the tristimulus video values to identify an optimum transfer function.

30. The video encoding apparatus of claim 29, wherein the instructions are such that the video encoding apparatus is operative to:
apply each of a plurality of transfer functions to the tristimulus values;
encode the result from each transfer function; and
compare each result.

31. The video encoding apparatus of claim 26, wherein the instructions are such that the video encoding apparatus is operative to encode the video content after the selected transfer function has been applied to the tristimulus values detected by the video camera.

32. The video encoding apparatus of claim 31, wherein the instructions are such that the video encoding apparatus is operative to encode an indication of the selected transfer function with the video content.

33. An apparatus for encoding video, comprising
processing circuitry;
memory containing instructions executable by the processing circuitry whereby the apparatus is operative to:
apply a transfer function to tristimulus values detected by a video camera;
wherein the transfer function is selected based on the video content.

34. A non-transitory computer readable recording medium storing a computer program product for controlling a video encoding apparatus, the computer program product comprising software instructions which, when run on processing circuitry of the video encoding apparatus, causes the video encoding apparatus to:
take a statistical measure of image luminance of tristimulus values detected by a video camera;
apply a transfer function to the tristimulus values detected by the video camera, wherein the transfer function is a parameterized function defined by at least one parameter; and
wherein the transfer function selected based on the statistical measure of image luminance.
